(19) United States
(12) Patent Application Publication
(10) Pub. No.: US 2022/0225598 A1
(43) Pub. Date: Jul. 21, 2022

(54) Fishing Vessel Catch Characterization and Sorting Table

(71) Applicant: Jacob Isaac-Lowry, Lexington, KY (US)

(72) Inventor: Jacob Isaac-Lowry, Lexington, KY (US)

(21) Appl. No.: 17/579,587

(22) Filed: Jan. 19, 2022

Related U.S. Application Data
(60) Provisional application No. 63/139,277, filed on Jan. 19, 2021.

(51) Int. Cl. A01K 97/22

(52) U.S. Cl. CPC A01K 97/22

(57) ABSTRACT

The present application discloses a portable workstation for sorting and characterizing a fishing vessel's catch which possesses a tabletop having reference markings on the top surface, a foldable leg on the proximal side of the table, a deck rail receiving slot on the distal side of the table, and a removable tabletop surface section which is received by shelf supports beneath the table.

### CROSS REFERENCE TO RELATED APPLICATIONS

This application claims priority from U.S. Provisional Patent Application 63/139,277 filed on Jan. 19, 2021.

### TECHNICAL FIELD

The apparatus of the present application relates generally to systems and devices to aid in catch sorting and characterization in fishing operations.

### BACKGROUND

Information about the health of offshore fisheries is general and uncertain about fish stocks and the condition of fishing grounds as a whole, about the health and abundance (or lack of it) of the many commercial varieties, of their location in abundance or deficit, of their migration patterns, and of their breeding patterns, seasons, and efficiencies. The gathering of most of this vital information currently falls almost exclusively to a few public inspectors and private researchers.

In jurisdictions that support and control the fishing industry, governments attempt to provide, within budgetary constraints, the inspection of and reporting on fishing operations and on the condition of fishing grounds and of fish stocks through variously named “departments of marine resources.” From time to time, this information may be augmented by the efforts of non-governmental fishing organizations, e.g., the FAO, which is part of the United Nations, and by the necessarily narrow interests of academic or institutional researchers.

Currently, the limited data collected by these means, and the analysis of such data, form the sole basis of governmental regulation of the fishing industry. The trouble is that, relative to the size of the industry and the volume of information necessary to form the basis of valid judgments, the number of persons collecting such information is small, making the accumulation of a statistically significant volume of fishery-related data difficult or, arguably, impossible.

Management of commercial and recreational fisheries has long been a point of conflict between governments and harvesters. This conflict is due to the common pool nature of the resource and the competing interests of various user groups that rely on the resource for food, income, and recreational opportunities. Policy choices for the management of aquatic food resources are typically multidimensional and involve a variety of regulatory instruments to control the harvesting so as to maintain a healthy population. Because fishery management plans are usually tied to the status of fish stocks, governments typically monitor and assess changes in the fish biomass on a regular basis.

Ensuring compliance with these fishery management plans is an increasingly difficult process, especially for off-shore fisheries, and compliance is an increasingly expensive process for the commercial harvester. Regulations intended to promote sustainable exploitation impact the species harvested, the physical attributes of the catch, the quantity of the catch, methods used in the catch, and efforts to minimize harm to protected species.

The primary limitations in fishery management plan development and compliance are the absence of quality data and the expense of shipboard observers. Fishery management decisions are often based on population models, but the models need quality data to be effective. Scientists, fishery managers, and commercial harvesters would be better served by the collection of more accurate data and through the elimination of shipboard observers. Additionally, the absence of cost-effective electronic monitoring systems harm the commercial harvester because various programs improve the profitability of commercial fishing through incentives tied to the use of on-board electronic monitoring.

There is a need for improved methods of gathering information on both kept and discarded commercially important species from a catch. Management decisions are currently based on information largely gathered by established federal surveys and observer programs which are costly to maintain. Under many past management plans, fisheries were managed by a DAS (Days at Sea) system. The DAS system allocates a certain number of fishing days to each vessel over the course of a year. When a vessel uses up its allocation of days, it can either cease operations until the following year or purchase additional fishing days from idle vessels. The DAS management strategy has come under scrutiny in recent years due to safety concerns and other issues.

Ideally, each catch is monitored, but this is an expensive and time-consuming process requiring significant man-hours. The recording of video and the coordinates of each catch greatly improves compliance with fishery management plans and provides a record that protects both fishery populations and those involved in commercial fishing.

Existing systems cannot be used on small vessels as they are essentially a “convenience store security system” using a CCTV camera hardwired into a boat. They have large footprints because they use multiple domed security cameras hardwired into the vessel in communication with a central computer installed in the wheelhouse. These existing systems have large footprints that take up precious space, use expensive components not amenable to relocation on a vessel or redeployment to another vessel, and require expensive maintenance and repair.

On-board observers are typically the only independent data collection source for some types of at-sea information required by fisheries, such as bycatch and catch composition data. Creel surveys, trip reports, and other data obtained directly from fishermen can have some dependent bias associated with it. Fisheries-dependent information is critical for the effective execution of fishery management plans, but on-board observers take up space that could be used for an additional crew member and are expensive. Recent data from NOAA suggests that electronic monitoring with currently available technologies is approximately ⅓ the cost of on-board observers.

Seasonal closures, catch limits, gear restrictions, and quotas have all helped maintain fish populations. However, the current data collection process put in place to reduce risk of overfishing has made commercial fishing less efficient and less profitable. That conflict has left commercial fishing operators unable to economically comply with government fishery management regulations.

### BRIEF DESCRIPTION OF THE DRAWINGS

FIG. 1 is a perspective view of the bottom of the fishing vessel catch characterization and sorting table of the present application.

FIG. 2 is a lateral side view of the fishing vessel catch characterization and sorting table of the present application.

FIG. 2 is a lateral side view of the fishing vessel catch characterization and sorting table of the present application.

FIG. 3 is a top-down view of the fishing vessel catch characterization and sorting table of the present application.

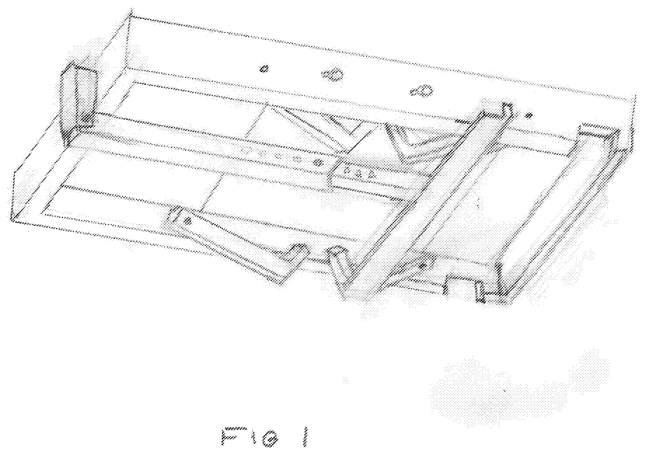

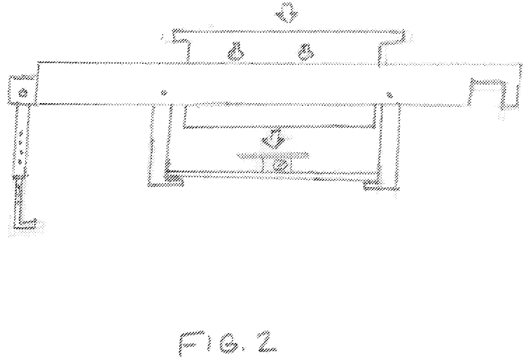

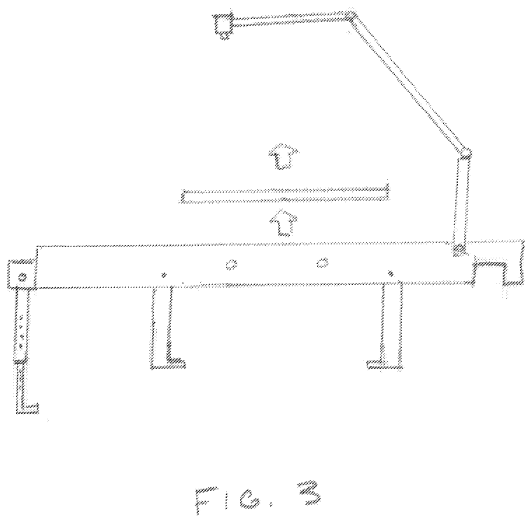

### DETAILED DESCRIPTION OF THE PREFERRED EMBODIMENTS

The present application discloses a workstation for use with a high-definition camera having a camera mount positioned above a tabletop surface having gradations or reference markings within the recording field of the camera. Using images acquired by the high-definition camera, algorithms analyze the image of the catch as each fish is placed on the surface within the camera's visual field. Each fish is placed on the reference surface within the camera's visual field and within the reference markings to permit the system to calculate the size of each fish. The system can also examine the shape of the body, the shape and placement of the fins, the shape and size of the scales, and other physical features to determine the species caught, its length, and its mass. Moreover, the device of the present application can also be configured to weigh the catch placed on the table.

The system automates the data collection process and reduces the time required for catch characterization by approximately 75%. The system can accurately identify species of fish of approximately 2 inches and larger. This cannot be achieved with a CCTV camera mounted up in the rigging. This is critical because the additional time required by data collection dramatically impairs catch handling catch handling efficiency.

Species in low individual numbers (A-type system) can be characterized by setting up the tables in a measuring board configuration, to run each fish one by one under the camera. The system collects the data, and the artificial intelligence system characterizes the fish and records its data parameters in a database which can be queried to produce a catch log. In alternative embodiment, no artificial intelligence system is utilized and the recordings are processed manually by visual review by a crew member during down time or upon return to port. The compiled data from either the computer processed or manually processed recordings is then provided to fishery management.

A handful of species account for a disproportionately large share of the catch (B-type system). The crew pre-sorts those into totes and the table is converted to show and directly weigh those pre-sorted totes under the camera to process and characterize the bulk catch. In an embodiment, the tabletop possesses a fixed tabletop section and a removable tabletop section. Removing the removable tabletop section of the table surface creates an orifice through which the base of a tote may pass. The removal of the table surface exposes a lower shelf beneath the table surface onto which a scale can rest and onto which the base of the tote is received. The lower shelf surface is ideally formed by unfolding platform arms which are hingedly affixed to the table beneath its top surface and which possess features onto which the removable table surface rests to form a shelf, i.e., platform, beneath the table. Alternatively, the table surface itself forms the platform of the scale. The weight is then provided either visually to be recorded by the camera or digitally by a data feed from the scale which is recorded by the system. Alternatively, the tote can be configured to provide reference marking for size estimation. In a still further embodiment, a reference grid or other marker can be superimposed over the image and calibrated to provide measurements as well. In a further embodiment, the table surface has gradations which permit measurements to be taken and a camera to be calibrated with objects of known dimensions. In an alternative embodiment, the table surface can either be freestanding from the sides or not-freestanding but releasable from the sides wherein the table surface is affixed to a scale and can be used to directly measure the weight of the catch. In an alternative embodiment, the table possesses features to removably affix the tote to the side of the table, i.e., workstation. In a further embodiment, the side of the table possesses keys extending from the side of the table onto which totes possessing keyways can be removably affixed.

In an embodiment, the workstations are portable. The tables collapse to be stored and the camera boom folds so the crew can use the workstation when needed and it doesn't occupy valuable deck space when not in use. The camera boom may be affixed to the table or a separate boom may be utilized. Being portable, the table can also be easily moved from boat to boat as needed. The device has at least one leg to support the proximal end and a slot or keyway to receive the side rail or other feature of the boat on which the distal end rests. In an embodiment, the leg is hingedly affixed to the proximal end of the table. When the distal end rests on the side rail, the sorter can quickly discard an unwanted catch back into the water. Having only one leg also reduces manufacturing costs, reduces the volume of the device for stowage, and reduces its weight.

In a still further embodiment, the height of the table is adjustable for use on boats having different height side rails by using elements found within the arts requiring adjustable height legs, e.g., a telescoping leg. In a still further embodiment, the resting foot or feet of the device are adjustable in pitch so as to accommodate the inclination of the deck surface. Mounting the camera on a boom and positioning it above and near the table surface assists in controlling the depth of field to accommodate for a sharper image and better resolution, which also results in better calibration for size determination.

Each table is converted back and forth while processing a haul to effectively absorb the variability in catch composition from haul to haul (C-type) which maximizes processing efficiency over highly variable catch compositions.

It should be understood that the Preferred Embodiment and alternatives thereof mentioned herein are merely illustrative of the present invention. Numerous variations in the use of the present invention may be contemplated in view of the following claims without straying from the intended scope and field of the invention disclosed herein.

To one of skill in this art who has the benefits of this disclosure's teachings, other and further objects and advantages will be clear, as well as others inherent therein. The disclosures herein are not intended to limit the scope of the invention, merely to provide context with which to understand the patent claims.

What is claimed is:

1. A catch characterization workstation comprising a table having a tabletop having a top surface and a bottom surface, a length, a width, a height, a proximal end, a distal end, internal side walls, external side walls, a proximal end side, a distal end side, a bottom surface, at least one leg hingedly affixed to said proximal end, and at least one slot extending from the base of at least one lateral side up toward the top of said lateral side on said distal end of said workstation so as to allow said distal end to securely rest on a support.

2. The device of claim 1, wherein said top surface of said tabletop possesses gradation markings.

3. The device of claim 1, wherein said tabletop is comprised of a fixed tabletop section and a removable tabletop section.

4. The device of claim 3, wherein said tabletop possesses platform stops beneath said removable tabletop section onto which said removable tabletop section can be placed.

5. The device of claim 4, wherein said platform stops are affixed to armatures which are folded adjacent to said bottom surface of said tabletop for storage when not in use and unfolded when used to support said removable tabletop section as a shelf.

6. The device of claim 1, wherein said at least one leg is adjustable in length.

7. The device of claim 6, wherein said at least one leg is adjustable in pitch.

8. The device of claim 1, wherein said workstation possesses at least one of a fixed camera boom and an adjustable camera boom.

9. The device of claim 1, wherein at least one of said internal side walls and external side walls are configured to receive a tote.

10. The device of claim 9, wherein said totes are removably affixable to at least one of said internal side wall and said external side walls using a key/keyway system.

11. The device of claim 3, wherein said tabletop removable section is a scale.
